(19) United States
(12) Patent Application Publication
(10) Pub. No.: US 2009/0268033 A1
(43) Pub. Date: Oct. 29, 2009

(54) Method for estimating connection relation among wide-area distributed camera and program for estimating connection relation

(76) Inventor: Norimichi Ukita, Nara-ken (JP)

Correspondence Address: POSZ LAW GROUP, PLC, 12040 SOUTH LAKES DRIVE, SUITE 101, RESTON, VA, 20191, US

(21) Appl. No.: 11/991,137

(22) PCT Filed: Aug. 30, 2006
(86) PCT No.: PCT/JP2006/317067

§ 371 Date: Feb. 28, 2008

(30) Foreign Application Priority Data
Aug. 30, 2005 (JP) 2005-249549

(51) Int. Cl. H04N 5/225

(52) U.S. Cl. 348/169; 348/E05.024

(57) ABSTRACT

An estimating method and program for estimating the connection relation among distributed cameras to use the estimated relation for monitoring and tracking many object in a wide area. The feature of the invention is not to need any object association among cameras by recognition of a camera image. Each camera independently detects and tracks objects entering/exiting an observation image, and the image coordinates and times of the moments when each object is detected first and last in the image are acquired. All the acquired data observed by each camera is tentatively associated with all the acquired data observed by all the cameras before the detection of all the acquired data observed by the each camera, and the associated items of the data associated for each elapsed time are counted. By using the fact that the elapsed time of correctly associated data with the movement of the same object has a significant peak in the histogram showing the relation between the elapsed time and the number of observations, the connection relation among the fields of view of cameras (presence/absence of overlap between fields of view, image coordinates at which entrance/exit occurs, elapsed time, and pass probability) is acquired according to be peak detection result.

### TECHNICAL FIELD

The present invention relates to a method for estimating the connection relation among distributed cameras and a program for estimating the connection relation among wide-area distributed cameras to be used for monitoring and tracking many objects in a wide area.

### BACKGROUND ART

For realizing real-world vision systems, object tracking, one of the most fundamental technologies, in particular, object tracking by multi-camera is useful technology for enlarging observation areas and observing targets from multi way.

The most crucial function for this object tracking is target identification. The technology which is simplified by analyzing consistencies in 3D information of the observed objects if fields of view of cameras are overlapped and their extrinsic parameters are known is popular (patent document 1).

A method of difference, binarization, and labeling by means of comparison between a camera input image with a background image is known (Patent Document 2).

However, in wide-area observation using many cameras, the fields of view shared by the cameras are narrow and spatially scattered, and observation of a static scene by blocking the traffic in a normal wide-area environment is difficult, so that camera calibration relying on a general calibration target is difficult.

Several methods for calibrating the extrinsic parameters of widely distributed cameras have been proposed, for example, initial calibration with observation results of moving objects, a method for improving the initial results, and calibration using landmarks with known 3]d positions measured by GPS (for example see non-patent literature 1).

In the multi-camera system using the camera calibration method using simultaneous observation results of moving objects described above, normally, as shown in FIG. 1-1(a), it is assumed that the entire observation region is observed by a plurality of camera fields of view, and the camera fields of view overlap each other (entire-field connecting type camera layout). Though it is suited to detailed observation in a large space, in order to use an investigation of activity of a moving object in wider areas (for example, an entire building, outdoor traffic network, and so on), it is necessary for camera positions which cover all routes. This assumption makes it practically impossible to employ a camera system for observing wilder areas because numerous cameras are required.

The camera arrangement that covers this all migration pathways is substantially difficult from both sides of the cost and management. Therefore, as showing in FIG. 1-1(b), the large area tracking that uses the case (camera arrangement of all view non-connected type) that there is no overlapping area of the camera field of view (isolation view) is needed. The object identification between plural in object tracking where such an invisibility area is included cameras is very a daunting problem compared with the object identification in overlapping area in the above-mentioned view.

Though, as measures method of this problem, some methods are already suggested (for example see non-patent literature 2.), as for both methods, connection relations between the camera fields of view (e.g., the presence of the overlapping region, the correspondence of an adjacent field of view stepping over the invisible region, and the transit times and transit probabilities of the invisible route) are considered, and it is improved performance of identification.

In these methods, for the connection relation information between the camera fields of view by human manual estimation, as the observation area grows and the number of the cameras increases, the connection relations between the camera fields of view becomes drastically more complex, there is a limit naturally.

Furthermore, automatic estimation is required to realize an online system that can update the information to cope with hardware troubles and adapt to changes in a scene. Therefore, not human manual estimation, a calibration method for automatically estimating the camera fields of view is desired.

Moreover, there are all view connection type and all view non-connected type mentioned above as arrangement of the multi camera.

However, it is general in the usage of the object tracking with an actual multi camera that the area where only the observation of tracks of the object that moves the area and the large area where a dynamic situation (person's behavior etc.) in the observation place of the object pursuit should be observed in detail is demanded exists together.

The present invention provides the method of a lot of presuming connected relation of a useful decentralized camera group for a continuous tracking of the object automatically in the environment where the overlapping area in the camera field of view is scattered.

[Patent document 1] JPA 2004-005462

[Patent document 2] JPA 2003-284059

[Non-patent Literature 1] R. Collins, A. Lipton, H. Fujiyoshi, and T. Kanade, “Algorithms for Cooperative Multisensor Surveillance,” in. Proc. of the IEEE, Vol. 89, No. 10, pp. 1456-1477, 2001.

[Non-patent Literature 2] V. Kettnaker and R. Zabih “Bayesian Multi-camera Surveillance,” in Proc. of CVPR99, pp. 253-259, 1999.

### DISCLOSURE OF THE INVENTION

### Problems to be Solved by the Invention

Generally, the connection relation among distributed cameras is indicated by camera fields of view and routes in and between the fields of view. Hereinafter, in the present specification, among field-of-view entering and exiting points of objects, a movement locus connecting two consecutive points will be referred to as “route,” and the ending points thereof will be referred to as “starting point” and “ending point.” Specifically, a route is indicated by the arrow in (a) and (b) of FIG. 1-1, which means an object locus connecting two points adjacent to each other among points at which an object is detected first and last in camera fields of view.

Actually what is observed within the image of camera is the area of 3D region. As illustrated in FIG. 1-2, the region within cone which extends from camera is drawn one of 3D.

A region occluded by obstacles (“unobservable area” in FIG. 1-2) is outside the camera field of view even if the region is within the image boundary.

In addition, about a route, the events such that ‘an object that was outside the field of view at the previous capturing timing is newly detected’, ‘an object that will leave the camera field of view at the next capturing timing is last detected’ are called IN, OUT each.

In the example illustrated in FIG. 1-2, IN1, IN2, OUT1, and OUT2 denote the positions where an object enters and exits a field of view, respectively. Consecutive two points observed at entering and exiting events compose a route. The earlier of the two points observed in called a starting point. The other is called an end point.

In FIG. 1-2, three routes, IN1·OUT1, OUT1·IN2, IN2·OUT2 exists. In this specification x·y means a route from the starting point x to the ending point y.

Arrows on the graph extend from the starting point to the ending point of a route. That is, each route is defined only by its starting and ending points, and object trajectories between and within fields of view are not represented by the route information. Though this is information on 3D coordinates as well as a route and field of view, in this investment, only information by 2D on images is dealt, and information by 3D restoration is not dealt. The data observed at IN and OUT events (image coordinates P(c) of camera C and time T at each entrance/exit event) are called IN data and OUT data, respectively.

An object of the present invention is to provide a method for automatically estimating the connection relation among distributed cameras useful for continuous tracking of many objects in an environment in which overlapping regions between camera fields of view are scattered. Herein, the connection relation among cameras can be roughly sorted into the following two types (class V information and class R information), so that these will be described, respectively, below.

At first, class V information means relationships between the camera fields of view, and the following three categories information (V1, V2 and V3) is concretely provided every possible pair of cameras (denoted by Ci and Cj of any camera fields of view).

V1: Presence or absence of route(s) of overlapping areas between a pair of any camera fields of view (Ci and Cj)

V2: Presence or absence of overlapping areas between the fields of view of a pair of any camera fields of view (Ci and Cj)

V3: If overlapping, a relative position and the extrinsic parameters between Ci and Cj (rotation and translation)

It is known that information V3 can be estimated by using a known calibration method. An object of the present invention is to estimate the relation between the fields of view of the above-described information V1 and V2.

Next, the class R will be described. The class R means the characteristics of a route (what is the probability that the object passes, and how much time is taken for the object to pass).

When entering and exiting data is observed in image coordinates P^{E} (C^{E}) of camera C^{E} at time T^{E}, this data must be identified with the IN/OUT data of the same object, which was observed right before T^{E}, in order to achieve object tracking. Superscripts B and E denote cameras and coordinates of the starting and ending points, respectively. It is similar in this specification below.

The object need not make all IN/OUT information before T^{E} the candidate of the pursuit solution since it is sure to pass the route, and only IN/OUT of “It was detected in either of vicinity of the starting point of the route with the terminal in the vicinity of P^{E}(C^{E})” and “It had been detected from T^{E} before T when time T was required to pass the route” information becomes a candidate solution. The following two kinds of information (R1 and R2) that expresses this limiting condition stochastically must characterize and be seen about the route set with the terminal in the vicinity of coordinates P^{E}(C^{E})

When an object was detected in T^{E} by P^{E} newly at the time, the observation information to relate to before T^{E} of this object is provided as class R information of a route having the P^{E} in the terminal. The class R information consists of two following information (R1, R2).

R1: Probability that and object detected in P^{E}(C^{E}) went through the route having the starting point P^{B}(C^{B}).

R2: Probability that it takes and object T^{E}-T^{B} to go through route P^{B}(C^{B})·P^{E}(C^{E}), where T^{B} denotes the time when the object was observed in P^{B}(C^{B}).

When the class R is known, when an object is newly detected at certain coordinates of a certain camera, candidates of a tracking result of the newly detected object can be narrowed down by comparing object detection information before the detection time and Class R.

The above-described information V1 and V2 are closely associated with the relative position relation of the cameras. For camera position estimation, measuring methods using a sensor that does not rely on image analysis such as distance measurement by means of a GPS or a wireless transmitter attached to the camera are known. However, according to these measuring methods, camera posture information cannot be obtained, and the methods cannot be used indoors where signals are blocked by many obstacles. In addition, there is an essential problem that, unless an image observing an actual object moving environment cannot be analyzed, class R information cannot be acquired. The method for estimating the connection relation among wide-area distributed cameras of the present invention can be applied to a camera group including mixture of the presence and absence of overlapping fields of view, can estimate information of class V (V1 and V2) and class R (R1 and R2), and is based on analysis of only camera images.

As described above, an object of the method and program for estimating the connection relation among wide-area distributed cameras of the present invention is to acquire connection relation information among the cameras by analyzing only actually observed image information to obtain information useful for tracking an arbitrary object in an actual environment.

### Means to Solve the Objects

The present inventor carried out various considerations and experiments and repeatedly studied these, and arrived at completion of a method and program for estimating the connection relation among wide-area distributed cameras of the present invention. Hereinafter, the method for estimating the connection relation among wide-area distributed cameras will be described.

In order to achieve the object, a method for estimating the connection relation among wide-area distributed cameras, includes, in a process of estimating the connection relation among distributed cameras in object tracking by means of a multi-camera, the steps of: detecting object entering and exiting points in each camera field of view; voting for associating all entering and exiting points with each other; classifying a correctly associated route and an incorrectly associated route based on similarity of coordinates of voted starting points and ending points and passage times; and estimating each field of view and characteristics of routes, wherein a route can be detected by using only camera images.

In the above-described constitution, the step of detecting object entering and exiting points in the field of view of each camera is processing of acquiring image coordinates and times at the moments of first and last detections of objects in camera images by detecting and tracking the objects that enter and exit from camera images observed independently by cameras.

The step of voting for associating all entering and exiting points with each other is processing of temporarily associating all acquired data observed by the cameras with all acquired data in all cameras observed before the detection times and counting the number of data associated by elapsed time among the associated data. When the elapsed time and the number of observations are shown in a histogram, for example, the elapsed time of correctly associated data according to movement of the same object shows a significant peak.

Next, the step of classifying a correctly associated route and an incorrectly associated route based on similarity of voted starting point and ending point coordinates and passage times is processing of detecting associated data corresponding to a real route excluding erroneous association and classification of associated data into each route by classifying differences in coordinates and observed times of associated data based on the similarity, and acquiring the connection relation (that is, route information) among camera fields of view based on the classification results. The step of estimating the fields of view and characteristics of routes is processing of estimating the relation among the fields of view, estimating starting point and ending point coordinates of routes among fields of view and probabilistic expressions of times required for passage, and estimating route types of the respective routes.

In the above-described constitution, at the step of estimating fields of view and characteristics of routes, it is preferable that geometric relations among fields of view are obtained by comparing any route type of a unidirectional field-of-view passing route, a single-field-of-view crossing route, an overlapping region passing route, a loop route, and a route between invisible fields of view with a detected correctly associated route. The reason for this is that the route type classification can also be used for estimating the relation between the camera fields of view of V1 and V3 from a set of detected routes and removing erroneously detected routes from the set of detected routes.

Furthermore, in the above-described constitution, it is preferable that the step of estimating the fields of view and characteristics of routes in the method for estimating the connection relation among wide-area distributed cameras includes at least a step of estimating probabilistic information of route coordinates from a set of starting point and ending point coordinates voted for the respective routes, and a step of estimating probabilistic information of route passage times from a set of voted passage times corresponding to the respective routes. The reason for this is that the connection relation among camera fields of view (coordinates of images which an object enters and exits from, passage times, and passage probabilities) can be obtained.

In the above-described constitution, it is preferable that the classification in the step of classifying a correctly associated route and an incorrectly associated route based on similarity of coordinates of voted starting points and ending points and passage times uses similarity classification of multidimensional vectors having vector elements including at least starting point coordinates, ending point coordinates, and passage times. The reason for this is that classification can be performed by totally considering uniformity of passage times and uniformity of starting point and ending point coordinates of routes when a large amount of data is observed.

In the above-described constitution, it is preferable that the step of classifying a correctly associated route and an incorrectly associated route based on similarity of coordinates of starting points and ending points and passage times classifies routes with the same voted object entering and exiting points into a route and its composite route according to the lengths of passage times.

In addition, a method for detecting and tracking objects including at least the above-described method for estimating the connection relation among wide-area distributed cameras is provided. In a system in which a plurality of cameras are connected by a network and image data of the cameras are loaded into a computer via a network, the program for estimating the connection relation among wide-area distributed cameras of the present invention makes the computer execute the above-described steps of the method for estimating the connection relation among wide-area distributed cameras.

In addition, a computer-readable storage medium storing the above-described program for estimating the connection relation among wide-area distributed cameras is provided.

### EFFECTS OF THE INVENTION

The method and program for estimating the connection relation among wide-area distributed cameras of the present invention are useful for distributed cameras including mixture of the presence and absence of overlapping fields of view and have an effect enabling estimation of route type classification (class V) regardless of whether they are used indoors or outdoors. In addition, by analyzing many actual loci of moving objects, the characteristics (class R) of routes can be estimated.

In the method and program for estimating the connection relation among wide-area distributed cameras of the present invention, it is not necessary to track objects in which identification uncertainty is high, and only observed information of actually moving objects are used, so that observation environmental conditions for successful tracking (such as conditions that only one object moves in an observed environment when learning the connection relation) are not necessary.

Furthermore, unlike calibration using a sensor (GPS, etc.) and calibration in which the environment is limited (the number of moving objects in the environment is reduced or landmarks such as LEDs that are easily detected and tracked are used, etc.), the connection relation can be estimated based on identification of a moving object identified only by recognition in camera images, so that the camera layout is not limited and the cameras can be freely laid out.

### BEST MODE FOR CARRYING OUT THE INVENTION

Hereinafter, an embodiment of the present invention will be described in detail with reference to the entire processing flowchart of the method for estimating the connection relation among fields of view of wide-area distributed cameras of the present invention shown in FIG. 2.

The method for estimating the connection relation among fields of view of distributed cameras of the present invention includes the steps of: detecting object entering and exiting points in each camera field of view (S1), voting for temporarily associating all entering and exiting points with each other (S2), classifying a correctly associated route and an incorrectly associated route (S3), and estimating the fields of view and characteristics of routes (S4). Hereinafter, the steps will be described in order.

(The step of detecting object entering and exiting points in each camera fields of view: S1)

The aim of probabilistic-topological calibration of widely distributed camera network related to this investment is to estimate topology of cameras. This topology of cameras is represented by camera fields of view and routes of within and between camera fields of view. In this investment routes are detected at first, the topological information within camera fields of view is estimated then on observed information of objects which passed every route.

A route is determined by the starting point and ending point. The starting point and ending point corresponds object entering and exiting points in camera field of view. To detect routes, the minimum required information is object entering and exiting points. To catch object entering and exiting points, detecting object domain from camera images and tracking to correspond successive detecting information and to catch object entering and exiting points is necessary.

On detecting and tracking objects, the robust optional object detection and mutual shielding under moving environment and the like are proposed.

When object tracking is designated as purpose, it is obtained enough steady results because it does not become big trouble even if there are some over detections and detection leak, because it is quite unlikely not to detect any object entering and exiting points even if some detection delay and no detection are occurred because of screening.

Meanwhile, on object tracking a failure is easy to happen because of shielding for long time by obstacles mutual shielding between moving similar objects. When tracking starts and ends, there is a problem to be unlikely to be corresponded to the same object information. However, if object detection is highly reliable, short-term tracking results to detect accurately at the moment every object is inside or outside field of view is reliable.

Therefore, for the analysis of the event, the entering and exiting information (coordinates of images which an object enters and exits from, and the time) to the most important field of view can be provided by existing method.

Thus, in the method for estimating related to this investment only entering and exiting information of this camera field of view is used.

To be corresponded object entering and exiting points with the starting and ending points of routes is necessary for detecting routes from entrance/exit information of camera field of view of objects. Hereinafter, in the present investment the data which come within field of view (observation image coordinates, time and camera identifier) is called as IN data and the data which come out field of view is called as OUT data. The starting and ending points of routes correspond to a pair of successive IN/OUT data of the same object.

Here, the kind of the route is described as follows. In the multi camera system where the presence of overlaps of the camera field of view exists together, the object entering and exiting shown in FIG. 3 in the observation space may happen. INᵢ and OUTᵢ (i is camera identifier) on FIG. 3 are represented the point which object enters field of view (detection point of new object on each camera field of view) and which object exits field of view (tracking end point within camera field of view) respectively. Routes are composed by a successive pair of IN or OUT data, for example IN/OUT, OUT/IN, IN/IN and OUT/OUT. X·Y represents a route from point X to point Y.

FIG. 3 illustrates that (a) a single field of view means entrance/exit of a single camera field of view, (b) it overlaps partly, (c) it is concluded and (d) no overlapping means entrance/exit between two camera fields of view. All entrance/exit in composing more than three camera fields of view can be expressed by (a) to (d) positions. According to FIG. 3 all routes can be classified into five categories below.

(1) INᵢ·INⱼ or OUTₚ·OUT_{q} (Here, i, j, p, q are arbitrary indexes.) are classified as route type 1 which consist of two field of view.

Route Type 1: Route Through One of Field of View

It means a route included in only in one of two overlapping field of view. For example, a route belonging to route type 1 in FIG. 3 is IN₃·IN₄ and OUT₃·OUT₄ shown in FIG. 3(b), and IN₅·IN₆ and OUT₆·OUT₅ shown in FIG. 3 (c).

(2) Next, INᵢ·OUTⱼ exists in field of view having INᵢ and OUTⱼ and is classified into two categories as following route type 2 and route type 3 depending on the combination of the field of view that observed this starting point and ending point.

Route Type 2: Route Through a Field of View

When INᵢ and OUTⱼ are object entering and exiting points of the same camera field of view, INᵢ·OUTⱼ means a route crossing a single camera field of view. For example, a route belonging to route type 2 in FIG. 3 is IN₁·OUT₁ shown in FIG. 3(a), IN₆·OUT₆ shown in FIG. 3 (c), and IN₇·OUT₇ and IN₈·OUT₈ shown in FIG. 3 (d)

Route Type 3: Route Through an Overlapping Area

When INᵢ and OUTⱼ are object entering and exiting points of the different camera field of view, INᵢ·OUTⱼ means a route overlapping regions between camera fields of view. For example, a route belonging to route type 3 in FIG. 3 is IN₄—OUT₃ shown in FIG. 3(b).

(3) OUTᵢ·INⱼ exists outside field of view having OUTᵢ and INⱼ and is classified into two categories as following route type 4 and route type 5 depending on the combination of the field of view that observed this starting point and ending point.

Route Type 4: Loop Route

When OUTᵢ and INⱼ are object entering and exiting points of the different camera field of view, OUTᵢ·INⱼ means a route between the camera fields of view without overlapping. For example, a route belonging to route type 5 in FIG. 3 is OUT₇·IN₈ shown in FIG. 3(d).

Route Type 5: Route Through an Invisible Area

When OUTᵢ and INⱼ are object entering and exiting points of the same camera field of view, OUTᵢ·INⱼ means a route that returns to the same field of view after having left the camera field of view. For example, a route belonging to route type 4 in FIG. 3 is OUT₂·IN₂ shown in FIG. 3(a).

Based on the above categorization, the connection relations (class V information) of the camera fields of view, that measured the starting point and ending point of the route, can be obtained.

However, in the present specification, the definition of the route is “consecutive lines owning two points of the starting point and ending point in the object locus”.

For instance, when the object passes the camera view where the plural that shows in FIG. 4 camera view is included, object entering and exiting points pair of the camera view (for instance, compound route consisting of connection of multiple routes such as IN₁·IN₃ of FIG. 4) where other camera view was stepped over is not detected as a route.

Therefore, the relation of the camera field of view pair (for instance, camera view C1 and C3 etc. of FIG. 4) with coming in succession cannot be detected though it doesn't have the route when the relations between the camera field of view are requested by processing only to the route.

Then, should it be assumed that the route type is applied to the compound route consisting of the connection of routes, and request the relations between the camera view of both ends of the route.

In the present invention, since the compound route is obtained in the process of the route detection, too the relation between necessary camera field of view can be obtained without omission.

The classification of the above-mentioned route type of (1) to (5) can be used to presume related to the connection of the camera view from the route set of the detection and to remove the mis-detection route.

(The Step Voting for Associating all Entering and Exiting Points with Each Other: S2)

The step (S2) voting for associating all entering and exiting points with each other is described. The pair of consecutive simplicity and the time series IN/OUT information cannot be considered to be a starting point and an ending point of the route under the environment where multi objects move at the same time. Therefore, it paid attention uniformity of passage times and uniformity of starting point and ending point coordinates of routes when a large amount of data is observed.

First of all, the uniformity of passage time is described. The uniformity of passage time is the certain kinds of objects (e.g., people walking, people jogging, and cars) needs almost the same transit time excluding a special situation that stops on the way and moves outside the observation environment when a certain kind of object passes each route. Therefore, a large amount of IN/OUT information is observed, and the pair of all IN/OUT information that can be the combination it is considered to be the starting and ending points of the route. And, the observation frequency between pairs that correspond to the real existence route at the elapsed time rises when the elapsed time between those is calculated.

The case of the object that passes the same route at a greatly different speed exists, the same route is detected in the position as a route different according to the difference of the passage time when the route is detected and it is classified in consideration of the uniformity of passage time. However, the purpose of a presumption method according to the present invention is to presume connected relation of the distributed cameras that uses it for the object pursuit, and time required to pass each routes information is included in connected information between fields of view in that. Therefore, the problem that the route with greatly different passage time is expressed as an alternate route is not caused.

Next, the uniformity of the starting and ending point coordinates is described. As for the uniformity of the starting and ending point coordinates, the IN/OUT information pair of different object tracks observed at intervals during that time might be included in the pair of IN/OUT information that there is a difference at the observation time at this level by chance.

In addition, there is a possibility that the pair corresponding to the starting and ending points of plural routes to which the passage time is equal is included also in the IN/OUT information pair that corresponds to the starting point terminal of the real existence route. However, since it is composed by the camera and the image coordinates of a different respectively starting and ending points, each route can classify the pair of each IN/OUT information severally as information on an appropriate route on the basis of the similarity of IN/OUT information on the starting point and ending point. In this specification as follows, the route consisting of the mis-correspondence will be called “an incorrectly associated route”, and a route for positive will be called “a correctly associated route”.

The number of IN/OUT information classified into the incorrectly associated route is sure to become small extremely as a result of this classification processing compared with the route for the correctly associated route observed without fail at each movement of the objects.

Well, a temporary all associating of IN/OUT information should be first acquired to detect the route on the basis of the uniformity of passage time and the uniformity of the starting and ending point coordinates. In a presumption method according to the present invention, it associates as all IN/OUT information and a pair of all cameras where each IN/OUT information was detected between IN/OUT information obtained by first observing a large amount of moving of the object to the field of view before at the observation time, and of each is considered to be the ending points and the starting point of the route. However, if associating the IN/OUT information that parted enough for a long time and was observed mutually need not be considered, and only associating the IN/OUT information on the threshold or less with the interval of the observation time is considered, it is enough.

The temporary associating set of the IN/OUT information is handled respectively as an independence and temporary associating set according to the camera to which the IN/OUT information on the starting and ending points is observed.

That is, when the temporary associating set that the starting point corresponds to camera B, and the terminal corresponds to camera E is written as S^{B,E}, a temporary associating of IN/OUT information to which the starting point is observed with camera B, and the terminal is observed with camera E comes to be voted as set S^{B,E}.

The starting point corresponds to camera B, and the ending corresponds to camera E, and that is, if the starting and ending points of a pair are observed in cameras CB and CE, respectively, this pair is voted into a set S^{B,E} of tentative pairs, when the temporary associating set is written as S^{B,E}.

Here, for N cameras, the camera pair of the starting and ending points of _{N}P₂+N sets is possible.

(The Step of Classifying a Correctly Associated Route and an Incorrectly Associated Route: S3)

Next, the processing that detects object route from a lot of vote results requested by the above-mentioned processing, that is, the step (S3) of which classifying a correctly associated route and an incorrectly associated route based on similarity of coordinates of starting points and ending points and passage times, is described.

First of all, sets of each camera pairs of each starting point terminal are displayed by the histogram for example (a horizontal axis is an elapsed time between routes, the spindle is an observed number.).

In this histogram view, the number of votes that corresponds at the passage time of the route for a correctly associated route comes to indicate a remarkably big value.

This shows the feature of uniformity of passage time mentioned above.

A presumption method according to the present invention has detected the route, without detecting the route by simple peak detection, by the classification into which the uniformity of passage time and the uniformity of the starting and ending point coordinates are integrated.

This is because in the route detection by simple peak detection, the following some problems are.

The first problem is the following. A clear peak is not to be observed when the travel time of the object that passes a certain route exists at intervals of time when plural peaks are near since it doesn't install in the sampling unit of the time axis and it varies at the route detection by simple peak detection.

Moreover, the second problem is to be included in the break-up travel time as which vote results that correspond to them are the same when plural routes for a correctly associated route to which the value at the elapsed time is close exist.
Moreover, the third problem is that the incorrectly associated route only for the correctly associated route exists together in vote results.

To reduce these problems, first of all, the observation entering and exiting coordinates set is classified by adjoining the entering and exiting point, and the peak is detected by voting on the histogram at the elapsed time between these classification point group (which is correspond to the starting and ending points of the route).

By the above-mentioned processing, only the route guidance information with a certain starting point or ending point in the edge point is voted on histogram, and it becomes easy to detect the peak.

However, there is the following problems of; the entering and exiting classification is independently done by each image and the relation of the starting point terminal is not considered; the number of classes (number of starting point and ending point in each image) is unknown though the entering and exiting coordinates set is classified by the class identification based on the Gauss mixture distribution; the Class R information on plural routes exists together in one route guidance information when the point that should be separately classified by mistake when the edge point in multiple pathways is adjacent is classified into one point.

The identification of these two kinds of routes is impossible only in the peak detection though not only the route that is the presumption target but also the compound route by the combination of plural routes is included in the route for positive.

Moreover, there is a problem that even a detailed route type classification is not considered.

Then, in the present invention, according to the step (S3) of which classifying a correctly associated route and an incorrectly associated route based on similarity of coordinates of starting points and ending points and passage times, by classifying 5 dimension vector in which the image coordinates and the elapsed time of the starting and ending points of vote results of each set S^{i,j} that the entering and exiting information is temporarily associated, and only the route for correctly associated route is extracted from S^{i,j}, and it is classified by vote results that correspond to each route.

Hereafter, it describes the step (S3) of which classifying a correctly associated route and an incorrectly associated route based on similarity of coordinates of starting points and ending points and passage time by dividing processing 1-5 referring to the classification processing flow chart of a correctly associated route and an incorrectly associated route shown in FIG. 5.

### (1) Processing 1: Multi-Dimensional Vector Making Processing (S31)

Five dimension vector set that consists at the starting point and ending point coordinates of each vote results of each set Sij with which IN/OUT information is temporarily associated and the elapsed time is assumed to be {V₁, . . . , V_{Ni,j}}.

Here, Vi=(x^{B}ᵢ, y^{B}ᵢ, x^{E}ᵢ, y^{E}ᵢ, tᵢ) denote a 5D vector comprising the image coordinates of the starting and ending points and the elapsed time tᵢ between them, and N^{i,j} denote the total number of the ballots in S^{i,j}.

### (2) Processing 2: Normalized Processing (S32)

It is normalized since the value of a quite different order will be input at the image coordinates and the elapsed time.

### (3) Processing 3: Classification Processing (S33)

Next, {V₁, . . . , V_{Ni,j}} is classified according to the LBG (Linde-Buzo-Gray) algorithm. The LBG algorithm is the one to calculate the code vector (It is a vector of the representative approximated best as for the vector under the gathering) of each subset obtained by the division of the vector under the gathering into two on the basis of the similarity. A presumption method according to the present invention repeats division until the mean distance from the all elements to the code vector becomes below the threshold in each subset that the division generation is done. Moreover, a small value is given experiencing to the threshold enough as classified into the set. Moreover, a small value is given experiencing to the threshold enough as classified into the subset with different a correctly associated route and an incorrectly associated route. By this processing 3, the correctly associated route set and the incorrectly associated route set can be classified.

It is considered that this over division doesn't come to use the detection route guidance information for the object pursuit, and in particular, the problem even if vote results corresponding to a certain route are divided as a result in which this processing 3 is not good.

As the reason, all routes with the possibility of making coordinates X a terminal are chosen as a candidate of the route that has passed this object when the object is newly detected in coordinates X of a certain camera when the object is pursued, these route guidance information are integrated, and information necessary for the object identification is obtained. All route guidance information over divided will be chosen as a candidate.

### (4) Processing 4: Solvent Wiping Removal of the Incorrectly Associated Route (S34)

The subset that is less than number (average—2.5 times standard deviation) is removed as an incorrectly associate route with an extremely small number of votes for the total of the vector included in each subset obtained from s j by the above-mentioned processing 1 to 3.

(5) Processing 5: Comparison Processing with Route Type (S35)

Only the correctly associate route can be detected by the above-mentioned processing 1 to 4 in most cases. However, the incorrectly associate route removes by the above-mentioned processing 4 when there are extremely a lot of the incorrectly associate routes and there is possibility of not cutting. Then, this incorrectly associate route of the removal that doesn't cut is removed by this processing by doing the comparison processing as the passing road type.

For example, route type 1 that the starting point and the ending point become IN·IN or OUT·OUT is always different view in the starting point and ending point. Therefore, the starting point and ending point are IN·IN or OUT·OUT, and field of view in the starting point and ending point an equal route becomes possible as an incorrectly associate route the removal.

The above-mentioned processing 1 to 5 is done to all temporary associating sets S^{i,j}. As a result, the obtained each subset will correspond to one correctly associated route severally.

In the following specifications, the correctly associated route obtained from the above-mentioned processing 1 to 5 will be written as RB,E={R^{B,E}ᵢ|iε{1, . . . , N^{B,E}}}.

N^{B,E} is the numbers of detection routes in the starting point camera B and the ending point camera E.

Moreover, the correctly associated route set (That is, subset of the above-mentioned processing 1 to 5) classified into route R^{B,E}ᵢ will be written as TCS^{B,E}ᵢ.

The compound route with which a consecutive detection target route connects and is formed is included in the correctly associated route obtained by above-mentioned processing 1 to 5.

This compound route overdetected can be removed by detecting the route set with the starting point in different view the ending point has the same point.

Hereafter, the processing of removing the compound route is described.

(The Processing of Removing the Compound Route)

### (a) Process a

It is assumed that sets of the correctly associated routes that makes a certain camera view E an ending point and makes different camera view Bᵢ and Bⱼ a starting point are shown R^{Bi,E} and R^{Bj,E} respectively.

It is assumed set TCS^{Bi,E}ₚ that is classified into the correctly associated route p in R^{Bi,E} and set TCS^{Bj,E}_{q} that is classified into the correctly associated route q in R^{Bj,E} including the observation result (the entering and exiting information) as which the ending point is the same.

When the elapsed time between starting point and ending point of associating in TCS^{Bi,E}ₚ is longer than that of associating in TCS^{Bi,E}_{q} among associating the entering and exiting information as which the ending point is the same, route R^{Bi,E}ₚ corresponding to the former is judged that the possibility that it is route R^{Bj,E}_{q} corresponding to the latter and is the compound route of other routes is high.

### (b) Process b

The above-mentioned processing a judges one only by associating it of the associating sets.

Therefore, the one associated with all of the set should be compared, and the relation between candidate RBiEp and composition route RBjEq of the compound route be confirmed.

The ratio of associating the entering and exiting information that the terminal is the same and the elapsed time of associating TCSBiEp is longer is calculated between associating included in both TCSBiEp and TCSBjEq.

It removes it considering candidate RBiEp of the compound route to be a compound route when this ratio exceeds the threshold.

### (c) Process c

The above-mentioned processing a-b is executed only a total camera several times considering all view to be camera view E.

After applying processing to all cameras, the route set that finally remains is constant without depending in the order of the camera that applies processing.

All the compound routes are removed by the above-mentioned processing a-c.

And, only the detection target route with the shortest elapsed time between starting point and ending point remains. The detection of all routes that are one of the presumption targets according to the present invention ends by the above-mentioned processing.

(Object Tracking from Vote Results of the Correctly Associate)

In the present invention, it votes on the entering and exiting pair to detect the route that connects between the camera view as mentioned above.

The pair of the entering and exiting information on the same object that passed the starting point and ending point of the route is voted on in the correctly associated route set to the correctly associated route each in this vote results.

That is, each vote results in the correctly associated route set corresponds to the tracking result of the object that moves between the camera field of view.

Therefore, according to the present invention, in the process of the route detection, it is understood to be able to track the object by off-line.

(The Step of Estimating Each Field of View and Characteristics of Routes: S4)

Next, the step of estimating each field of view and characteristics of routes is described. The step of estimating each field of view and characteristics of routes is composed of processing that estimates information related to the connection between the camera field of view of the detection route set and processing to acquire both starting point information on the route and information of the elapsed time between starting point and ending point.

(1) The processing that estimates information related to the connection between the camera view of the detection route set

The detected each route can be classified severally compared with five kinds of route types mentioned above. For example, all routes where the starting point and the ending point are IN·IN or OUT·OUT are classified into the route of type 1. However, as mentioning above, the entering and exiting pairs other than the route should be classified to detect all the relations of the overlapping camera field of view. Therefore, in the present invention, the classification object is all correctly associated route.

Moreover, both class V1 information and class V3 information on the route that is connected information between the camera fields of view can be acquired on the basis of five kinds of route type classifications that have been obtained.

Here, class V1 is information that the pair of the camera view has among route type 1 and 3 has overlap, and have no overlap between the combinations of other view.

Moreover, class V3 is information that an invisible route exists between the field of view pairs that have it among route types 5, and there is no route between other field of view pairs that do not have overlap.

### (2) The Processing to Acquire Both Starting Point Information on the Route and Information of the Elapsed Time Between Starting Point and Ending Point

Next, processing to acquire both starting point information on the route and information of the elapsed time between starting point and ending point is described from average coordinate data and decentralized data of the starting point and ending point of all routes.

Each coordinates μ^{B}ᵣ, μ^{E}ᵣ, covariance procession Σ^{B}ᵣ, and Σ^{E}ᵣ of average (x, y) of the starting point and ending point of route r is obtained from the correctly associated route set classified into each route r.

Several Ncᵣ of this average coordinates, a covariance procession, and a correctly associating under the gathering is assumed to be weight, and class R1 information is requested by the following procedure (a) to (c). Here, class R1 information is probability P_{R1}(C^{B}, P^{B}, C^{E, P}^{E}) that the object was observed by coordinates P^{B} of camera field of view C^{B} at the end when the object is newly detected in image coordinates P^{E} of camera field of view C^{E}.

(a) When probability Q(P^{E}, μ^{E}ᵢ, Σ^{E}ᵢ) of becoming new detection coordinates P^{E} is assumed to be normal distribution for all routes with the terminal in camera view C^{E}, coordinates of ending point Eₚᵢ of route R^{. ,E}ᵢ are requested by the following expression 1.

Moreover, new detection coordinates PE are requested by using the sum total after weight N_{ci} is multiplied by this Q(P^{E}, μ^{E}ᵢ, Σ^{E}ᵢ) and probability P(P^{E},E_{Pi}) corresponding to ending point E_{Pi} (average coordinates μ^{E}ᵢ, covariance procession Σ^{E}ᵢ) of route R^{. ,E}ᵢ is requested by the following expression 2.

All routes R_{. ,E}=R^{. ,E}₁ . . . R^{. ,E}_{N} (R^{. ,E}ᵢ show the route to which only the ending point is decided).

$$\begin{matrix}Q ( P , μ , Σ ) = \frac{1}{{( 2 π )}^{\frac{d}{2}} {\vert Σ \vert}^{\frac{1}{2}}} exp ( {( P - μ )}^{T} {Σ}^{- 1} ( P - μ ) ) & [ Expression 1 ] \\ P ( {P}^{E} , {Ep}_{i} ) = \frac{Q ( {P}^{E} , {μ}_{i}^{E} , {Σ}_{i}^{E} ) {Nc}_{i}}{{\sum }_{i = 1}^{{N}^{\cdot , E}} Q ( {P}^{E} , {μ}_{i}^{E} , {Σ}_{i}^{E} ) {Nc}_{i}} & [ Expression 2 ]\end{matrix}$$

(b) When sets of routes with the starting point in camera field of view C^{B} in route R^{.,E}ᵢ are assumed to be R^{B,E}=R^{B,E}₁, . . . , R^{B,E}_{N}, probability Q(P^{B}, μ^{B}ⱼ, Σ^{B}ⱼ) that coordinates in starting point Bₚⱼ of route R^{B,E}ⱼ become P^{B} is requested by the above-mentioned expression 1 about all routes in R^{B,E} as well as the above-mentioned processing (1).

(c) The sum total of multiplication value of probability Q and probability P is target class R1 information of a presumption method according to the present invention. Class R1 information is obtained by the following expression 3.

$${P}_{R 1} ( {C}^{B} , {P}^{B} , {C}^{E} , {P}^{E} ) = {\sum }_{x = 1}^{{N}^{B , E}} P ( {P}^{E} , {Ep}_{x} ) Q ( {P}^{B} , {μ}_{x}^{B} , {Σ}_{x}^{B} ) \qquad [ Expression 3 ]$$

Class R1 information when all field of view and coordinates are considered to be a starting point and ending point mutually can be presumed according to the average coordinates, the covariance of the starting point and ending point of all routes, and the observed associating total as described above.

On the other hand, class R2 information can be calculated from average μ^{B,E}ᵣ and decentralization σ^{B,E}ᵣ at the elapsed time that requires it to move between starting point and ending point in sets of the correctly associated route voted as each route r. Q(T, μ^{B,E}ᵣ, σ^{B,E}ᵣ) obtained by the above-mentioned expression 1 is a probability whose time required to move this route r is T.

When class R information is used to pursue the object, multiplication value PR1 (C^{B}, P^{B}, C^{E}, P^{E})·Q(T, μ^{B,E}ᵣ, σ^{B,E}ᵣ) of the probability obtained from class R1 information and the probability obtained from class R2 information is obtained as a probability whose time of the passage of the movement of the object from coordinates P^{B} of camera field of view C^{B} to coordinates P^{E} of camera field of view C^{E} is T.

### Example 1

FIG. 6 shows the case where three cameras are observing two kinds of object tracks. There are six kinds of routes that are the detection targets, that is, IN1·IN2, IN2·OUT1, OUT1·OUT2, IN4·OUT4, OUT4·IN3, and IN3·OUT3.

All of the entering and exiting information on all cameras where each the IN/OUT information was detected between IN/OUT information obtained by first observing a large amount of the entering and exiting of the object to camera field of view before at the observation time is associated as a pair, and of each is considered to be a ending point and a starting point of the route in a presumption method according to the present invention as mentioned above. Associating IN/OUT information that parted enough for a long time and was observed mutually need not be considered. If only associating IN/OUT information on the threshold or less with the interval of the observation time is considered, it is enough. In case of FIG. 6, time that some room was added at the time required to pass the route of OUT4·IN3 that corresponds to a longest route becomes a threshold.

Moreover, as it was the above-mentioned, the temporary associating set of IN/OUT information is handled respectively as an independence and temporary associating set according to the camera to which IN/OUT information on the starting point and ending point is observed. Therefore, as shown in FIG. 6, if there are three cameras (camera 1 to 3), the temporary associating set of the following combinations by nine kinds of (Camera pair of the starting point and ending point of NP2+N piece against number N of cameras) exists. The combinations by nine kinds of are camera 1·camera 2 (S^{1,2}), camera 1·camera 3 (S^{1,3}), camera 2·camera 3 (S^{2,3}), camera 2·camera 1 (S^{2,1}), camera 3·camera 1 (S^{3,1}), camera 3·camera 2 (S^{3,2}), camera 1·camera 1 (S^{1,1}), camera 2·camera 2 (S^{2,2}), and camera 3·camera 3 (s^{3,3}). Next, the concrete example of the vote at the passage time between view where all of the entering and exiting was temporarily associated is described as an example of the case of FIG. 6 referring to FIG. 7-1 and FIG. 7-2.

FIG. 7-1 and FIG. 7-2 are the results of using and displaying the histogram of each camera pair of each starting point and ending point as for the temporary associating set obtained when the case shown in FIG. 6 is observed. Here, a horizontal axis is the elapsed time between routes, and the spindle is an observation frequency.

As shown in FIG. 7-1 and FIG. 7-2, it is understood that the number of votes that corresponds from the uniformity of passage time at the passage time of the correctly associated route indicates a remarkably big value. Other peaks are the compound routes corresponding to the route where the peak enclosed with the oval in the example of FIG. 7-1 and FIG. 7-2 is a presumption target.

Next, FIG. 8 shows the example of the temporary associating set obtained when the case of FIG. 6 is observed. The arrow in FIG. 8 shows the example of the temporary associating set in the figure. Here, FIG. 8(a) shows associating set S^{1,2} inside and FIG. 8(b) shows associating set S^{2,2} inside. Such an incorrectly associated route is an example of vote results of the incorrectly associated route “False correspondence” in FIG. 8, and is included during each set S^{i,j} (i and j are arbitrary camera identifiers).

### Example 2

### Results of Simulation Experiments

Example 2 is conducted to confirm the robustness of the present invention by simulation, confirming how a results of the route detection of the present invention changes from the ideal value according to error and fluctuation of object detection position and transit time between the field of view of a camera and object number moving simultaneously. FIG. 9 shows a top view of all observed scene used in the simulation experiment of example 2. This simulate a situation observing object moving on a horizontal scene by vertical downward camera from above. Rectangle Vi (iε{1, 2 . . . , 1 2}) represents field of view of the camera Ci (corresponds to imaging area of 640×480 pixel) and dotted line represents moving trajectories. If there is no observed noise and fluctuation of moving trajectories, that is, under ideal condition, a number of routes of detection goal is 78 (37 bidirectional routes and 4 unidirectional routes

The following 3 kinds of experiments are conducted under an experimental setting above.

(1) experiment 1: confirmation of rise and fall of a number of routes by fluctuation of object detecting position
Although fluctuation is from fluctuation of real object moving in the environment and from the detection error from image, in this experiment 1, it is represented by fluctuation from real trajectories in the observed image grouping both factors. The fluctuation is given by assuming normal distribution in x, y coordinate independently.
(2) experiment 2: confirmation of rise and fall of the number of routes by fluctuation of velocities of objects
To express the fluctuation of object velocities, a value is given for moving velocities of each objects in the environment that is changed from some standard velocities according to normal distribution.
(3) Experiment 3: confirmation of rise and fall of the number of routes according to object number to observe simultaneously.

The results of experiment 1 is shown in table 1, the results of experiment 2 is shown in table 2 and the results of experiment 3 is shown in table 3. In the column of route number in the table, the rise and fall (+, −) from ideal value 78 routes and number of false-correspondence routes (value underlined) are shown and in the column of success rate in the following table 3, the probability (unit: %) of getting only one true-positive pairing is shown in the results of object tracking obtained from the results of route detection. However, the success rate in the experiment 1 and 2 in which the number of the object to observe simultaneously is only one is omitted because the rate becomes 100% naturally.

TABLE 1

| | Coordinates | | | | | |
|---|---|---|---|---|---|---|
| | decentralization | | | | | |
| | 0 | 2 | 4 | 8 | 16 | 32 |
| Number of routes | ±0 | ±0 | ±0 | +2, −2 | +2, −11 | +2, −12 |

TABLE 2

Speed decentralization

| | 0 | 2 | 4 | 8 | 16 | 32 |
|---|---|---|---|---|---|---|
| Number of routes | ±0 | ±0 | ±0 | +1 | +5 | +11 |

TABLE 3

| | Simultaneous number | | | | | |
|---|---|---|---|---|---|---|
| | of observations | | | | | |
| | 1 | 2 | 4 | 8 | 16 | 32 |
| Number of routes | ±0 | ±0 | ±0 | ±0 | +1 | +10 |
| Success rate | 100 | 100 | 100 | 99 | 94 | 86 |

“the variance of coordinate”, “the variance of velocities” and “the number of object observed simultaneously” are the variance of observed the entering and exiting (x, y) coordinate [pixel], the variance of object moving velocities in the scene and the object entering and exiting observed in each image in a time unit respectively.

In addition, the fluctuation of the object detected coordinate in the tables 1 to 3 above is given assuming the normal distribution in the environment. In addition, for expressing the fluctuation of object velocities, as moving velocity of each object, a value is used by changing some standard velocity according to the normal distribution.

In addition, each experiment was conducted under the conditions below, in order to verify only the influence of varying parameter, except the varying parameter, “the variance of coordinate observed is 0 pixel”, “the moving speed of all the objects is constant”, “the number of the object observed simultaneously is 1”, and the appropriate constant value was given for threshold value throughout all the experiments.

FIG. 10 shows an example of raise and fall of detected routes in simulation in example 2. (a) shows raise and fall of detected routes in experiment 1, (b) shows that in experiment 2 and (c) shows that in experiment 3.

About the fall of routes in experiment 1, the endpoint of the ideal route (P₁·P₂ and P₁·P₅ in FIG. 10(a) left figure) entering from the field of view V₉ to V₁₀ in FIG. 10(a) was observed mixed by fluctuation, and as a results, the route from the field of view V₉ to V₁₀ was merged to one (P₁ P₂ in the right figure). On the contrary, as the distance between the endpoints P₃ and of the routes entering from V₁₀ to V₁₁, making P₂ vicinity as start point, the two routes are detected independently even if some fluctuation of observed point are appeared. In this case, IN information observed at P₂ vicinity is classified two kind; starting point to P₃ endpoint and starting point to P₆ ending point (P″₂ and P′₂ in FIG. 10(a) right-handed figure) and constitute routes P′₂·P₆ and P″₂·P₃.

About rise in experiment 1, as trajectories was observed which did not pass through the field of view V11 at moving from P₅ to P₈ of left-handed figure due to fluctuation in FIG. 10 (a), route P′₂·P′₆ (FIG. 10 (a) right-handed figure) was newly detected.

About rise in experiment 2, as a result that the time interval from point P₁ to P₂ (in FIG. 10 (b) left-handed figure) was fluctuated due to the fluctuation in object moving velocities, the route was divided to P₁·P₂ and P′₁·P′₂ (FIG. 10 (b) right-handed figure) with the different time intervals.

About the rise of routes in experiment 3, because IN/OUT information observed simultaneously in FIG. 10 (c) was increased, false-correspondence of IN information at P₂ and OUT information at P₁ could not be removed and false-correspondence route P₂·P₁ was detected. As a result, overlap between field of view V₆ and V₈ was thought to be judged to be detected.

From above results, the following characteristics about route detection could be understood to confirm. From the results of experiment 1, the fluctuation in the detected coordinates yields rise and fall of detected routes but the false-correspondence is not confirmed to appear. From the results of experiment 2, the fluctuation of velocities of objects is confirmed to yield neither fall of routes nor false-correspondence. From the results of experiment 3, the increase of frequency of the object entering and exiting into image yields increase of false-corresponded routes. If false-correspondence is detected, though the error on relation speculation of the field relations of camera views, the present invention is confirmed to be able to detect routes stably as long as the entering and exiting frequency becomes extremely large.

While the rise and fall of detected routes number change depending on a threshold of LBG algorithm for stopping classification of set of the tentative pair, the characteristics about rise and fall of route are invariable. In this rise and fall, rise and fall routes besides the false corresponded routes corresponds to the results of rise or fall of the classification of the entering and exiting points. This rise and fall as well as the those depending on thresholding in LBG algorithm, do not have an adverse effect when the speculated results adopted to the object detection. The problem is the number of false corresponded routes and the more the number increased, the more it becomes an cause of tracking failure because narrowing down the object tracking is done by considering the object routes which is really impossible. Consequently, even if the detected pixels and the moving velocity of the object fluctuate, the estimated results was confirmed to supply useful information to object tracking after that.

In addition, from the results of table 3 above, success rate of the results of object tracking obtained as the results of route detection is confirmed to be extremely high except the case in which false corresponded route was detected.

In example 3, as FIG. 11, the action of the present invention was confirmed under the environment where 12 cameras, C₁ to C₁₂, were distributed indoors. All the cameras conducted asynchronous photographing but the observed time is known by synchronize the inner clock of the computer regulating photographing by each camera. Photographing was done in daytime (AM 9:00 to PM 7:00) on 3 weekdays. About 300 people engaged in everyday activities during daytime hours.

In each camera, 320×240 pixel images at 1 second intervals were captured and was used for input and confirmation of the action of the present invention. By a known methods, front image was extracted and gravity center of each object region detected based on proximity of extracted images mimicked as object coordinates. In addition, object tracking in observed images were conducted based on simple proximity of coordinates and on similarity of region size. Objects for observation are all walking people (but walking speeds varies) and number of entering and exiting objects detected in each observed image matrix of each camera were 7238, 7910, 11789, 13782, 12376, 6792, 7067, 7856, 8178, 12574, 12456 and 12786 in the order of C1-C12.

FIG. 12 shows example of the entering and exiting detection of walking people into the field of camera view at the observed image of cameras. FIG. 12(a) shows success example within the field of view of camera C2 and FIG. 12(b) shows failure example of tracking within the field of view of camera C₁. Both FIG. 12(a)(b) are observed images of camera which was put at the height of about 2.2 m from the floor and a little bit downward from the horizon.

In the case of camera image put a little bit downward from the horizon, stable object is difficult compared to object images observed from overhead (for example, observed image of camera C₁₀, C₁₁, C₁₂ in FIG. 11). For Example, in FIG. 12(b), object A IN-detected at (image 1) and object B IN-detected in (image 2) overlapped in (image 3) and discrimination of object A and object B became impossible. As a result, OUT information of object A was considered OUT information of object B in (image 4).

However, as object ID is not included in IN/OUT information which is input information of link relation proximity method of the present invention, such failure of object tracking cause no influence. Stated as above, important input information in link relation proximity method of the present invention is only entering and exiting coordinate and time. As shown in FIG. 12 (a) (b), short-time tracking for object A and B was succeeded and IN/OUT information of object was obtained. But in the case that multiple objects was overlapped in images at the entering and exiting time, detected coordinate slightly goes off from the true coordinates.

From the entering and exiting information, 130 routes (59 bidirectional and 12 unidirectional routes) were detected. The mean number voted into each true corresponded routes classified to each route was 2139.

FIG. 13 shows an example for detection tracking of example 3. ellipse and arrows represents position and variance of start point and end point and correspondence of start point and end point, respectively. Number on arrows shows mean transit time between routes. In addition, arrow line weight is proportional to number of correspondence voted to the route. In FIG. 13, route which is considered over-division was put together to on route and start point and end point of adjacent different route is put together to one ellipse. In addition, when detected route was checked up with observed image manually, there were many results which is considered to be over-divided of routes (about 40) but there was no false detection because every route corresponds to real route. Moreover drop out of detection was not found.

Class V information was obtained from the results of route detection. Class V information obtained is shown as follows. Camera pair of field of view with route (V1)

C₁-C₂, C₁-C₄, C₂-C₄, “possible combination of every pairs within C₃, C₄, C5, C₁₀, C11, C₁₂”, C₆-C₇, C₇-C₉, C₈-C₉
Camera pair of field of view with overlapping region (V2)
C₁-C₂, “possible combination of every pairs within C₃, C₄, C₅, C₁₀, C₁₁”, C₆-C₇, C₈-C₉.

Next, one example of class R information obtained as class V information(concerning to observed image of C₅, C₂, C₁ in FIG. 13) is shown as follows.

R1; The mean and variance of point A in observed image of camera C₅ was (56.1 m 71.8) and (4.1, 2.2) respectively.
R2; The mean transit time (second) of each route is shown by an integer with each arrows in FIG. 13.

In addition, 300 of object transfer between the field of view of camera from all observed sequence were extracted and compared with the results of object tracking obtained at route detection, only two tracking failure was found. But as strict segmentation of objects was not done in object detection of main experiment, there is a case that those were detected as one object. In the present invention, if the group (one object) can be corresponded among the field of view correctly is considered as tracking success.

Then, the effect given by input number of the entering and exiting information and thresholding was verified. The threshold value of the present invention are 3 kinds as following (1)-(3).

(1) maximum value of the difference of detection time of the entering and exiting information pair tentatively corresponded
(2) threshold value of determination of division end tentatively corresponded by LBG algorithm.
(3) threshold value of complex route detection

But the maximum value of the difference of detection time of IN/OUT information pair tentatively corresponded is easily determined manually. And as already shown that the result of threshold of above (3) complex route detection is extremely stable against threshold change, we estimate experimentally the effect of threshold value of determination of division end tentatively corresponded by (2) LBG algorithm above.

Graph of FIG. 14 shows the experimental results of threshold effect of determination of division end tentatively corresponded y LBG algorithm. FIG. 14 (a) shows rise and fall of route detection rate of true correspondence and false correspondence against voted pair and (b) shows rise and fall of route detection rate of true correspondence and false correspondence against threshold value. The vertical line of the graph of FIG. 14 (a) (b) concurrently shows true-positive (rate of true route detection=detected true routes number/true routes number) and False-positive (rate of detecting routes except true routes=false detection number/true routes number) considering 130 detected routes true in above experimental results. In addition, horizontal line of FIG. 14 (a) shows mean value of correspondence of the entering and exiting information classified to each route (voted pair). And horizontal line of FIG. 14 (b) shows threshold value of determination of classification end by LBG algorithm. But, each factor of classified 5 division vector is normalized to 1. Neither missing of detection nor false detection were shown around 0.01-0.05.

But false-detection is dramatically increased when threshold value becomes under 0.01. As factor of this, it is thought that; almost all factors of divided sets become extremely, significant difference in factor number of sets of true correspondence and false correspondence and discrimination of both sides becomes difficult. From this, getting appropriate results is difficult if the extreme standard is used such that the fewer the threshold value is, the better.

In the present invention, even if multiple objects overlapped in camera images, more stable results can be obtained by detecting coordinate of gravity center of each object correctly.

From example 3 above, it is confirmed that the present invention can implement probabilistic-topological calibration of distributed cameras actually.

### INDUSTRIAL APPLICABILITY

According to the estimating method of the present invention, calibration of many cameras can be automated, so that it is expected that this method is utilized in a real world viewing system requiring continuous object observation by using a plurality of cameras distributed in a wide area. In detail, it is useful for road traffic monitoring systems and security systems for buildings, etc.

### BRIEF DESCRIPTION OF THE DRAWINGS

FIG. 1-1: Figure for explanation of observed field of view of dispersed camera system (a) overlapping field of view (b) isolated field of view

FIG. 1-2: Figure for explanation of object entering and exiting points at observed field of view of dispersed camera system.

FIG. 2: Flow diagram of entire procedure of probabilistic-topological calibration among field of view of widely distributed cameras of the present invention.

FIG. 3: Figure showing the combination of entering and exiting of field of view of cameras (here, ellipse depicts field of view of cameras and arrows depicts trajectories of object.)

FIG. 4: Figure showing one example of route passing through multiple inclusive relation of field of view

FIG. 5: Flow diagram of classification procedure of true corresponded route and false corresponded route

FIG. 6: Figure showing one example of camera field of view and route of observation object

FIG. 7-1: Histogram of vote of time between field of view in each camera pair (1)

FIG. 7-2: Histogram of vote of time between field of view in each camera pair (2)

FIG. 8: Example for assembled figure of vote result corresponded superimposed on camera image

FIG. 9: Bird-eye view of whole observation scene used in the simulation experiment of example 2

FIG. 10: Figure showing rise and fall of detected route in the simulation of example 2 (in the figure, the bottom of arrow represent the ideal detection result and arrowhead represent rise and fall of detected route according to observation). (a) shows rise and fall of detected routes in experiment 1, (b) shows those in experiment 2 and (c) shows those in experiment 3.

FIG. 11: Birds-eye view and observed image of whole observed scene in example 3 (upper: 1st floor, below: 2nd floor)

FIG. 12: Figure showing detection example of entering and exiting into camera field of view of walking people in observed image of cameras in example 3, (a) shows success example within the field of view of camera C2, (b) shows failure example of tracking within the field of view of camera C1.

FIG. 13: Figure showing one example of detected route in example 3

FIG. 14: Figure showing experimental results of threshold effect of determination of division end tentatively corresponded by LBG algorithm, (a) shows rate of detected routes of true correspondence and false correspondence against voted pair number, (b) shows rise and fall of rate of detected route of true correspondence and false correspondence against threshold value.

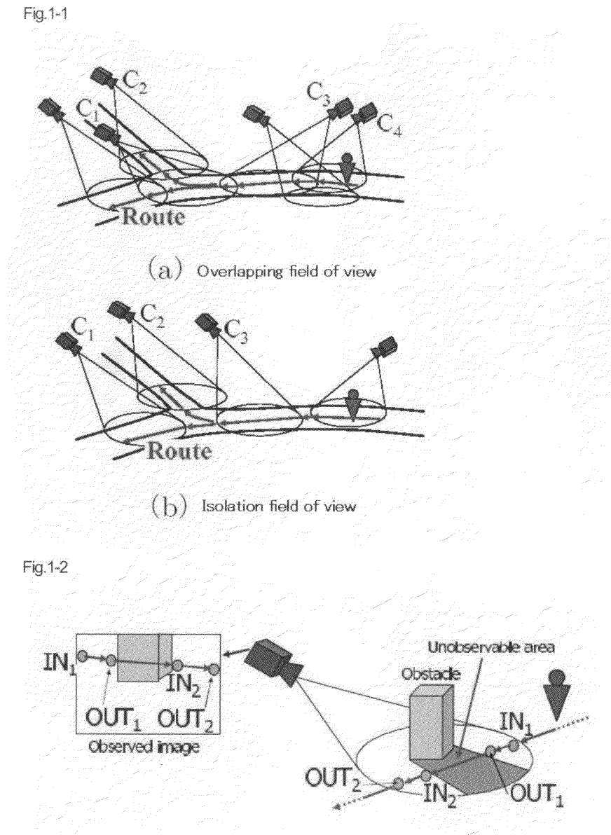

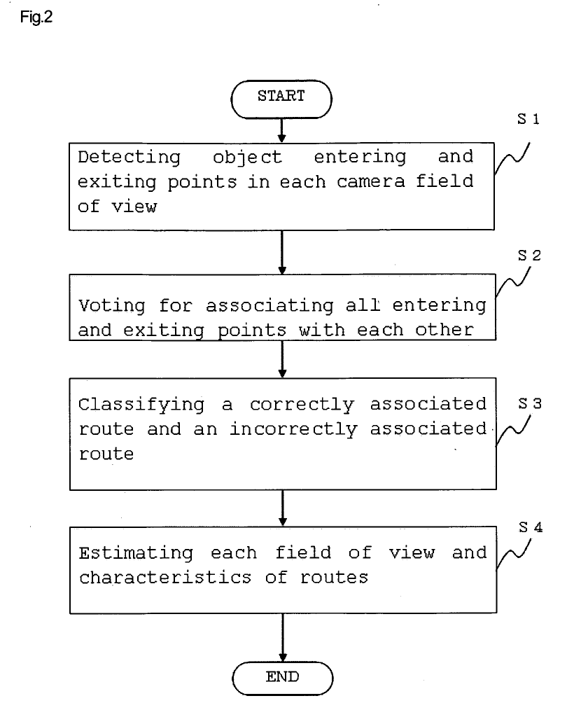

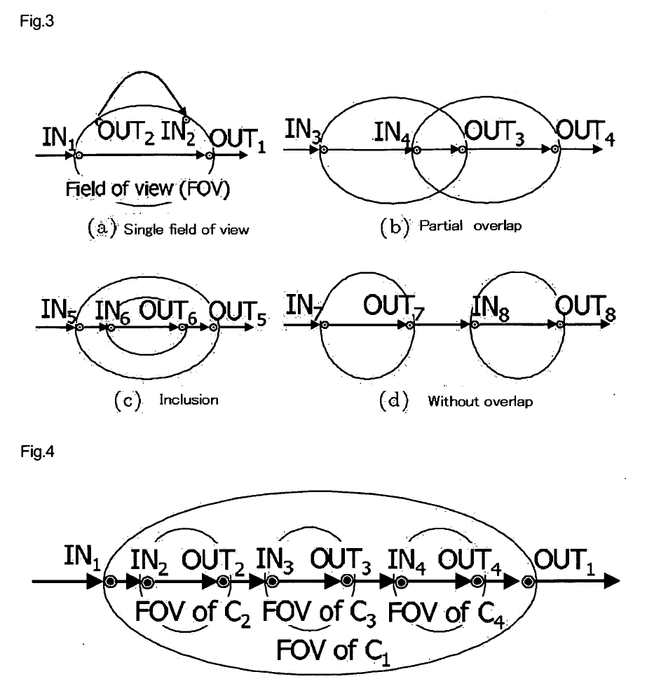

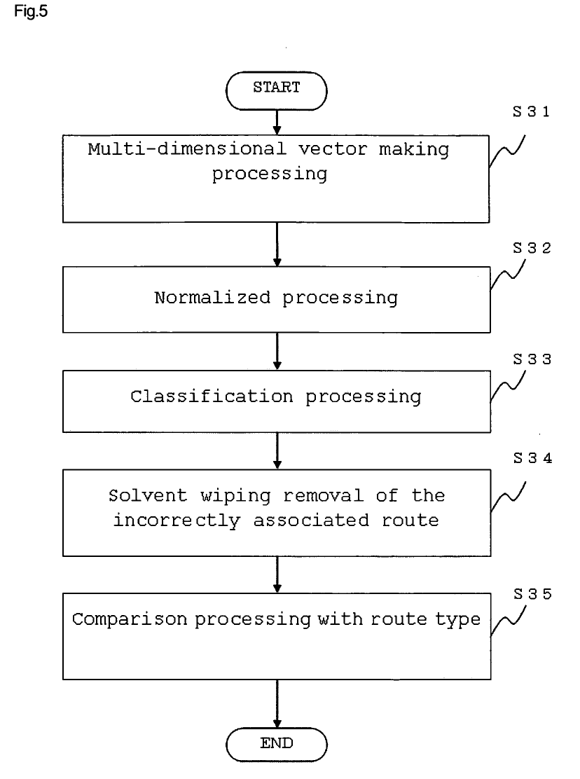

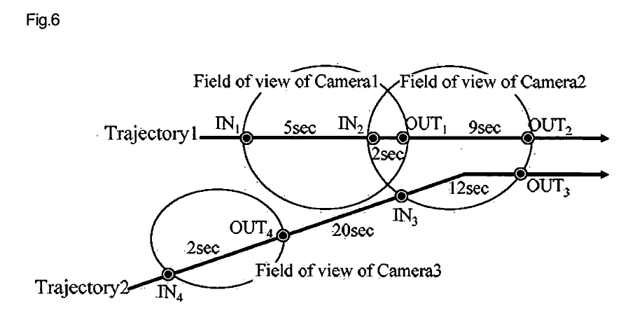

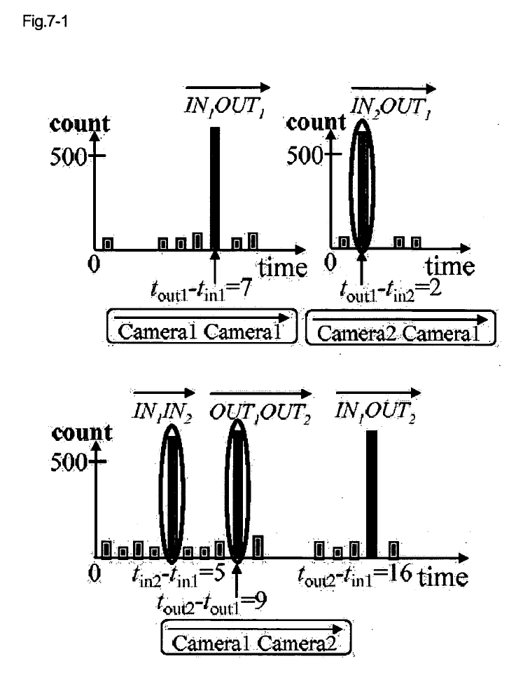

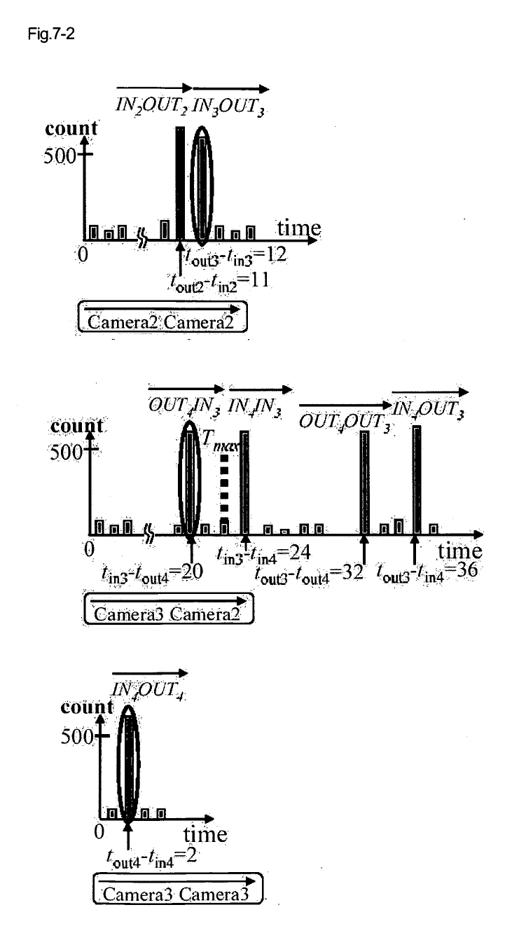

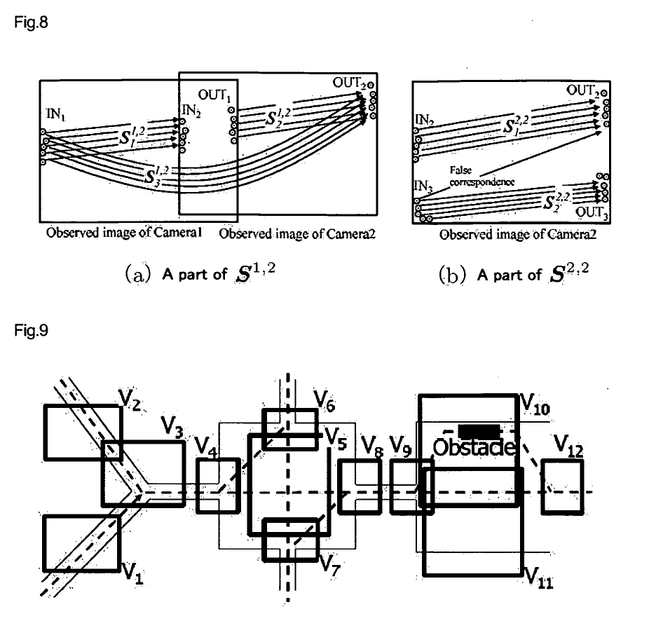

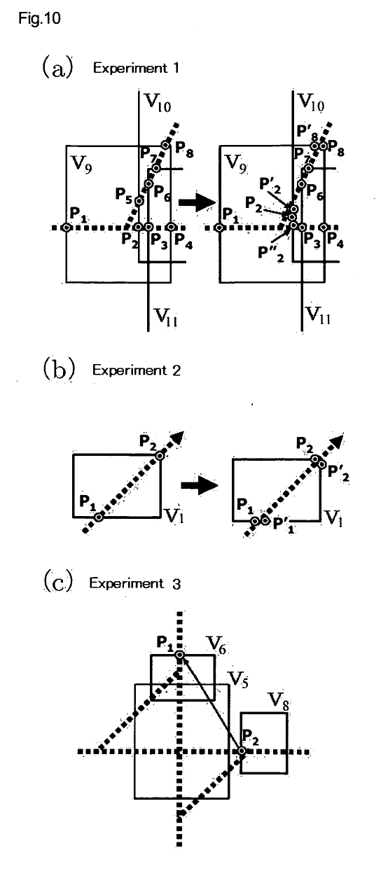

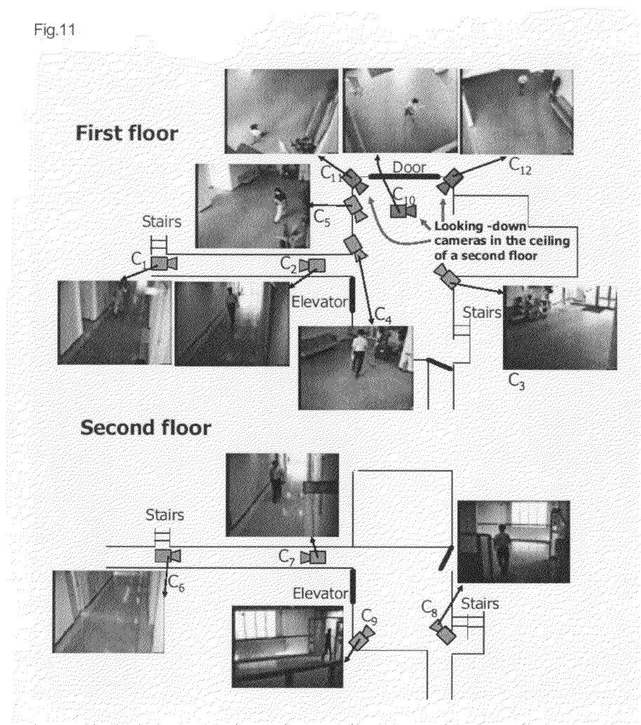

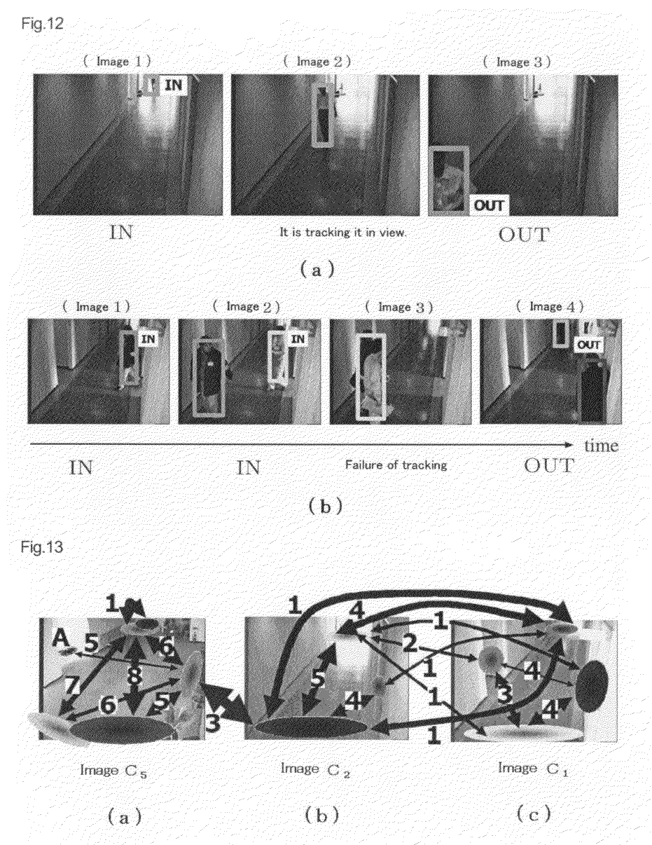

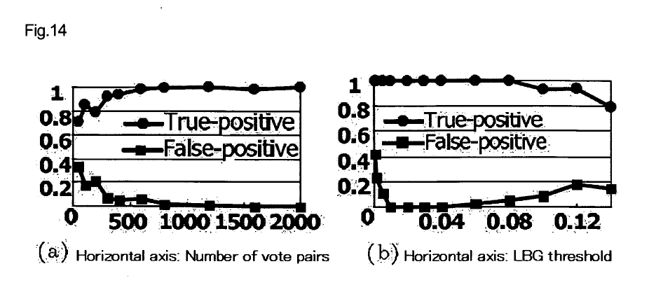

1. A method for estimating the connection relation among wide-area distributed cameras, comprising, in a process of estimating the connection relation among distributed cameras in object tracking by means of a multi-camera, the steps of:
detecting object entering and exiting points in each camera field of view; voting for associating all entering and exiting points with each other; classifying a correctly associated route and an incorrectly associated route based on similarity of coordinates of voted starting points and ending points and passage times; and estimating each field of view and characteristics of routes, wherein a route can be detected by using only camera images.

2. The method for estimating the connection relation among wide-area distributed cameras according to claim 1, wherein the classification in the step of classifying a correctly associated route and an incorrectly associated route based on similarity of coordinates of voted starting points and ending points and passage times uses similarity classification of multidimensional vectors having vector elements including at least starting point coordinates, ending point coordinates, and passage times.

3. The method for estimating the connection relation among wide-area distributed cameras according to claim 1, wherein the step of classifying a correctly associated route and an incorrectly associated route based on similarity of coordinates of starting points and ending points and passage times classifies routes with the same voted object entering and exiting points into a route and its composite route according to the lengths of passage times.

4. The method for estimating the connection relation among wide-area distributed cameras according to claim 1, wherein the step of estimating fields of view and characteristics of routes obtains geometric relation among the fields of view by comparing five route types of a unidirectional field-of-view passing route, a single-field-of-view crossing route, an overlapping region passing route, a loop route, and a route between invisible fields of view with a detected correctly associated route.

5. The method for estimating the connection relation among wide-area distributed cameras according to claim 1, wherein the step of estimating the fields of view and characteristics of routes includes at least the steps of: estimating probabilistic information of route coordinates from a set of coordinates of starting points and ending points voted in the respective routes; and estimating probabilistic information of route passage time from a set of passage times voted for the routes.

6. An object detecting and tracking method including at least the method for estimating the connection relation among wide-area distributed cameras according to claim 1.

7. A program for estimating the connection relation among wide-area distributed cameras which makes a computer execute the method for estimating the connection relation among wide-area distributed cameras according to claims 1.

8. A computer-readable storage medium storing the program for estimating the connection relation among wide-area distributed cameras according to claim 7.
